(19) United States
(12) Patent Application Publication
(10) Pub. No.: US 2025/0390320 A1
(43) Pub. Date: Dec. 25, 2025

(54) DECLARATIVE ENRICHMENT OF USER-DEFINED WORKFLOWS

(71) Applicant: Acronis International GmbH, Schaffhausen (CH)

(72) Inventors: Petr Gurin, Krakow (PL); Ivan Kukhta, Istanbul (TR); Marina Smolyanaya, Sofia (BG); Serg Bell, Costa del Sol (SG); Stanislav Protasov, Singapore (SG)

(21) Appl. No.: 18/753,512

(22) Filed: Jun. 25, 2024

(51) Int. Cl. G06Q 10/0633; G06F 9/451; G06F 9/54

(52) U.S. Cl. CPC G06F 9/451; G06F 9/542

(57) ABSTRACT

Systems and methods for creating, provisioning, and executing custom events and actions within a dynamic workflow automation platform are described and contemplated herein. The method comprises generating a workflow incorporating a custom event and a custom element. The method further comprises a subscription and notification system for executing the workflow.

### TECHNICAL FIELD

Embodiments relate to the field of cloud integration and process automation. More particularly, embodiments facilitate the creation, provisioning, and execution of custom events and actions within a dynamic workflow automation platform.

### BACKGROUND

In the ever-evolving field of cloud integration and process automation, ensuring dynamic integration of workflows across software remains a paramount challenge. Traditional solutions require manual implementation of predefined schemas for workflow creation, which can be time-consuming, inconsistent, and prone to human error. Moreover, many workflow automation algorithms are closed, or otherwise not designed to handle variance in cross-platform data structure and content, resulting in limited flexibility and scalability.

Therefore, there is a need for systems and methods that provide enriched, platform-agnostic workflow management.

### SUMMARY

Embodiments described or otherwise contemplated herein substantially meet the aforementioned needs of the industry. Embodiments described herein include systems and methods for creating, provisioning, and executing custom events and actions within a dynamic workflow automation platform. By allowing third-party developers to integrate custom events and actions into the platform without complex coding, embodiments address the need for more flexible and scalable workflow automation solutions.

Embodiments are configured to receive, validate, and provide custom events and actions, allowing for a customizable and scalable workflow automation platform. Embodiments allow third-party users to perform codeless enrichment of the platform workflows' elements library. The elements created by these users can inherit the platform elements properties and combine both user-defined and platform properties in a single custom workflow element. A workflow can be associated with custom events, for example, such that a workflow engine can subscribe to be notified when the custom event occurs.

In a feature and advantage of embodiments, incorporation of custom events and custom actions can allow for dynamic workflow automation tailored to specific third-party services or applications, allowing for more dynamic use cases compared to the one-size-fits-all approach of existing solutions.

In a feature and advantage of embodiments, learnings from implementations of previously generated workflows can improve efficiency over time. For example, a workflow including custom workflow elements can be generated and executed. The effectiveness of the workflow, and particularly the custom workflow elements can be evaluated and used to improve future workflow elements, such as by refining properties of the workflow elements, and subsequently revising the workflow or storing the improved custom workflow elements for future use.

In an embodiment, a system for managing a workflow using custom workflow elements comprises an elements database configured to store a plurality of workflow elements and a workflow platform communicatively coupled to the elements database. The workflow platform comprises at least one processor and is configured to implement an interface engine, a workflow engine, and an event engine.

In an embodiment, the interface engine is configured to perform one or more of the following. The interface engine can provide a graphical user interface (GUI). The interface engine can receive, via the GUI, a custom event comprising an event identity, an event name, and an event schema, wherein the event schema includes an association between the custom event and one of the plurality of workflow elements, and a custom action corresponding to the custom event, wherein the custom action comprises a callback, a callback schema, an action, and an association between the custom action and one of the plurality of workflow elements. The interface engine can include an API callback gateway (ACGW) that is configured to send outbound action requests, for example, based on custom actions. The interface engine can be configured to incorporate a public API. The event engine can receive event data associated with the event schema. In an embodiment, the custom event can be a third-party defined event or a predefined platform event.

In an embodiment, the workflow engine is configured to perform one or more of the following. The workflow engine can generate a workflow incorporating the custom event and generate an action request comprising an indication to perform the action based on the callback, wherein the action request includes data according to the callback schema.

In an embodiment, the event engine is configured to perform one or more of the following. The event engine can receive, from the workflow engine, a subscription request associated with the custom event. The event engine can receive event data. The event engine can determine that the event data is valid based on a comparison of the event data to the event schema. The event engine can send an indication that the custom event occurred to the workflow engine based on the subscription request and the determination that the event data is valid. The ACGW can be configured to send the action request based on the indication that the custom event occurred.

In an embodiment, the event engine is configured to automatically configure an external (e.g., third-party) cloud service to send an action response associated with the action request to the ACGW based on the custom event or a predefined condition. For example, the event engine can send the event schema to the third-party cloud service.

In an embodiment, a method for method for managing a workflow using custom workflow elements comprises receiving, via a graphical user interface (GUI): a custom event comprising an event identity, an event name, and an event schema, wherein the event schema includes an association between the custom event and one of a plurality of predefined workflow elements, and a custom action, wherein the custom action comprises a callback, a callback schema, an action, and an association between the custom action and one of the plurality of predefined workflow elements; generating a workflow incorporating the custom event and/or the custom action; generating an action request comprising an indication to perform the action based on the callback, wherein the action request includes data according to the callback schema; receiving, via a public API, event data associated with the event schema; determining the event data is valid based on a comparison of the event data to the event schema; determining the custom event is associated with an active workflow subscription status; and sending, via an API callback gateway (ACGW), the action request.

In an embodiment, the method can comprise receiving, via the ACGW, an action response associated with the action request; validating the action response; and executing a portion of the workflow based on the action response.

In an embodiment, a non-transitory computer readable medium comprising instructions that, when executed by a processor, cause the processor to implement: an interface engine configured to: provide a graphical user interface (GUI), receive, via the GUI: a custom event comprising an event identity, an event name, and an event schema, wherein the event schema includes an association between the custom event and one of a plurality of predefined workflow elements, and a custom action, wherein the custom action comprises a callback, a callback schema, an action, and an association between the custom action and one of the plurality of predefined workflow elements; receive event data associated with the event schema via a public API; an API callback gateway (ACGW); a workflow engine configured to: generate a workflow incorporating the custom event, and generate an action request comprising an indication to perform the action based on the callback, wherein the action request includes data according to the callback schema; and an event engine configured to: receive, from the workflow engine, a subscription request associated with the custom event, send, via the ACGW, the action request, receive, via the ACGW, an action response associated with the action request, determine whether the action response is valid; and send, based on the subscription request and a determination that the action response is valid, an indication that the custom event occurred to the workflow engine, wherein the workflow engine is configured to execute a portion of the workflow based on the indication that the custom event occurred.

### BRIEF DESCRIPTION OF THE DRAWINGS

Subject matter hereof may be more completely understood in consideration of the following detailed description of various embodiments in connection with the accompanying figures, in which:

FIG. 1 is a block diagram of a system for generating dynamic workflows, according to an embodiment.

FIG. 2 is a block diagram of a system for generating dynamic workflows, according to an embodiment.

FIG. 3 is a block diagram of a system for generating dynamic workflows, according to an embodiment.

FIGS. 4A-4B are process flow diagrams of a method of generating dynamic workflows, according to an embodiment.

FIG. 5 is a flowchart of a method of generating dynamic workflows that incorporate custom workflow elements, according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

Systems and methods for the creation, provisioning, and execution of custom events and actions via a dynamic workflow platform are described and contemplated herein. The dynamic workflow platform can be a cloud-based engine configured to handle cross-software workflows, including management of workflow elements and execution. This allows third-party developers to perform codeless enrichment of the workflow platform's elements library. The elements created by third-party developers can inherit the platform elements properties and combine both developer-defined and platform properties in a single custom element.

Workflows can be user-defined or automatically generated and present configurable processes, for example, to automate ad hoc user activities. Workflows generally comprise the following workflow elements: a trigger, an action, a property, and a condition. As will be described, each of the aforementioned elements can comprise multiple respective elements, such as at least two triggers, at least two actions, at least two properties, or at least two conditions.

Workflows can comprise one or more triggers, which are events that initialize the execution of the workflow. A trigger can be predefined (e.g., known by a platform) or customized. A trigger can initialize execution of an entire workflow or a subset of processes within a workflow. For example, a trigger can serve as a transition between stages of a workflow. For example, a trigger can serve to resume a workflow after a stopping condition is detected. A (e.g., each) platform provides a library of events that can be used as triggers. Events that can act as a trigger generally include user login, ticket creation, device reboot, and similar operations. A trigger can be time-based.

Workflows can comprise one or more actions. An action is an automatic, certain operation that can be executed by the platform. Example actions include deleting a file, installing software, blocking a user, terminating a process, or sending a communication (e.g., an email, report, etc.). In an embodiment, an action can comprise an atomic operation that can be implemented without any interruption of any other process (e.g. a small atomic operation). In an embodiment, an action can comprise a large atomic operation or group of small atomic operations that cannot be interrupted by any other process. An atomic operation in a workflow refers generally to an operation that is indivisible and executes in a single, uninterruptible step.

Workflows can comprise one or more properties. Properties comprise particular event attributes or action attributes. For example, a user login event can incorporate a username or a login as attributes. For example, a send-email action can incorporate a header, a body, or a receiver as attributes. In examples, a list of properties can be associated with a workflow.

Workflows can comprise one or more conditions. A condition is a logical expression that defines the next operation of workflow execution. In examples, conditions can be based on criteria that must be met for an action to be executed within a workflow. For example, a condition can specify that a program must be closed before a device reboot action is taken. Conditions can include escalations, such as procedures for escalating issues or tasks to higher levels of authority or responsibility.

In examples, workflows can comprise feedback loops or mechanisms for collecting and incorporating output to improve the efficiency or efficacy of a workflow. For example, performance of a workflow can be evaluated and adjusted by monitoring workflow data.

General implementation of a service that drives the workflow inside a platform can include population of an internal workflow element library that can comprise triggers, actions, properties, and conditions. A user or an artificial intelligence (AI) algorithm, such as a bot, can leverage the service to select an event from the workflow elements library, set up a trigger to prompt an action, establish a condition, and define properties associated with the event, trigger, action, or condition. Allowing open access to develop the workflow element library can diversify the processes that can be automated, improving flexibility. For example, an elements library of a workflow platform can be enriched to include third-party defined properties. For example, workflow elements created by third parties can combine with existing platform properties in a single custom element.

To facilitate an open workflow element library, users (e.g., platform and third-party developers) can be provided with development tools to create custom workflow elements (e.g., triggers and actions) and define properties. For example, a developer portal, such as a graphical user interface, can be provided to users.

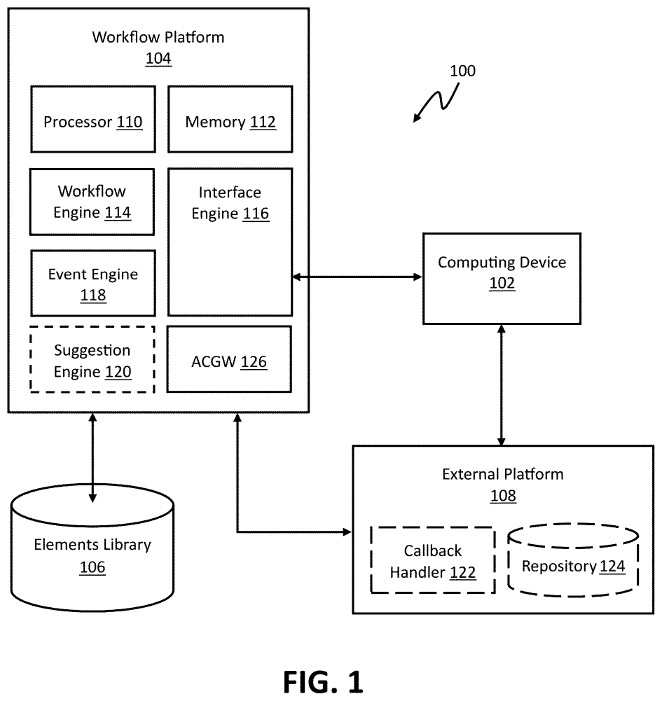

Referring to FIG. 1, a block diagram of system 100 for generating dynamic workflows is depicted, according to an embodiment. System 100 generally comprises a computing device 102, a workflow platform 104, an elements library 106, and an external platform 108.

Computing device 102 comprises an electronic device in communication with system 100. In particular, system 100 can provide one or more workflow elements to create and execute a custom workflow on computing device 102. In an example, computing device 102 can be desktop computer, a laptop computer, tablet, mobile computing device, server, workstation, or Internet-of-things (IoT) device, among other electronic devices. Though depicted as protecting a single computing device, system 100 can, in other embodiments, include a plurality of computing devices 102, such as a networked system of devices. In embodiments, computing device 102 can be utilized by a user to interact with other components of system 100, such as workflow platform 104 to obtain one or more workflow elements, for example from elements library 106.

Workflow platform 104 generally comprises processor 110, memory 112, workflow engine 114, interface engine 116, event engine 118, and optionally, suggestion engine 120. Workflow platform 104 generally provides capabilities to create and execute a workflow. In examples, workflow platform 104 is configured to allow for customization of workflow elements, including triggers, actions, properties, and conditions. Memory 112 comprises primarily RAM (Random Access Memory) or volatile memory and ROM (Read-Only Memory), which is non-volatile memory used to store firmware or software and performs diagnostics. Secondary scan also be provided, such as Hard Disk Drives (HDDs), Solid State Drives (SSDs). Memory can also include cache memory, which is a smaller and faster memory type that stores copies of the data from frequently used main memory locations.

In an embodiment, as illustrated in FIG. 1, workflow platform 104 is implemented on a single device, such as a server, having its own processor and memory. In embodiments, workflow platform 104 can be a cloud-based service such that customization and execution of associated workflows can be distributed across a network of multiple computing devices (e.g., with each device having its own processor and memory).

Embodiments described herein include various engines, each of which is constructed, programmed, configured, or otherwise adapted, to autonomously carry out a function or set of functions. The term engine as used herein is defined as a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware. In one example, the engines described herein are executed by a processor (e.g. an ASIC) according to instructions stored on memory operably coupled to the processor.

An engine can itself be composed of sub-engines, each of which can be regarded as an engine in its own right. Moreover, in the embodiments described herein, each of the various engines corresponds to a defined functionality; however, it should be understood that in other contemplated embodiments, each functionality can be distributed to more than one engine. Likewise, in other contemplated embodiments, multiple defined functionalities can be implemented by a single engine that performs those multiple functions, possibly alongside other functions, or distributed differently among a set of engines than specifically illustrated in the examples herein.

Workflow engine 114 supports workflow management and execution. For example, workflow engine 114 is configured to profile custom elements and declare associated properties. For example, workflow engine 114 can define a custom workflow template to automate the execution of tasks according to defined conditions and dependencies.

Workflow engine 114 allows a user, for example a user of computing device 102, to enhance workflow elements libraries, such as elements library 106. In one aspect, enhancement of workflow elements libraries can be performed in a declarative (e.g., code-less) way. For example, workflow engine 114 can facilitate declaration of custom event schema with unique properties; declaration of event linked entities (e.g., to combine custom elements with the platform elements); declaration of custom workflow actions based on a platform callback and/or a third-party callback handler (e.g. callback handler 112); declaration of links (e.g., associations) between custom action properties and platform properties; and declaration of a method for selection of workflow element properties based on a callback to a third-party callback handler.

In an embodiment, workflow engine 114 is configured to correlate workflows between identified systems using enhanced libraries. For example, workflow engine 114 can incorporate workflow elements (e.g., events, triggers, actions, conditions, properties) associated with a first system to trigger actions at a second system. Correlations, associations, and links between cross-system data can be defined by a user, for example via interface engine 116, or automatically determined, for example via suggestion engine 120.

In an embodiment, workflow engine 114 is configured to perform task assignment and allocation. In one aspect, workflow engine 114 can support dynamic routing decisions that consider factors such as task priority, resource availability, and process constraints. In another aspect, workflow engine 114 can route workflow items to appropriate users or systems when enforcing conditions (e.g., process rules). For example, workflow engine 114 can assign actions to systems based on predefined criteria such as processing capabilities, connection strength, and availability. For example, workflow engine 114 can perform action reassignment to ensure efficient workload distribution and resource utilization.

In an embodiment, workflow engine 114 can support dynamic security and access control for workflows. Workflow engine 114 can incorporate security policies, authentication mechanisms, and access controls to protect sensitive data and ensure compliance with regulatory requirements. Role-based security (e.g., based on user profiles), encryption, audit trails, and data privacy measures can be implemented according to embodiments. In such embodiments, elements library 106 can be enriched to consider a profile of a user (e.g., a user of computing device 102) and/or a control level. For example, workflow engine 114 can implement administrative actions that are associated with an elevated access level. In such an example, a non-administrative user can customize a workflow with functionality or sensitive data on behalf of an administrator user (e.g., who will later execute the workflow). Accordingly, workflow elements, for example as stored in elements library 106, can be classified based on third-party security considerations.

Interface engine 116 provides input/output capabilities of workflow platform 104. In an embodiment, interface engine 116 can comprise an interface, such as a graphical user interface, configured to display related event topic fields and schemas and receive user input. For example, a user can define custom workflow elements and declare their properties through interface engine 116.

Interface engine 116 can include graphical or text-based interfaces for defining and designing workflows. In an embodiment, interface engine 116 generates monitoring dashboards (e.g., reporting tools and analytics capabilities) to track the performance, efficiency, and compliance of workflows.

Workflow customization via interface engine 116 can be codeless, for example, such that users can visually map out the sequence of actions, triggers, and conditions that make up a process using drag-and-drop tools or scripting languages. Functionalities for managing workflow components (e.g., Get, Post, Put, Delete) can be associated with back-end code, such as through an automation API, according to an embodiment.

In an embodiment, interface engine 116 integrates with other systems, applications, and databases to access data, trigger events, and exchange information. Connectors, APIs, and adapters, can allow for interoperability, which can be provided by external platform 108. For example, interface engine 116 can send a defined custom event via a public API.

In examples, workflow platform 104 comprises an API callback gateway (ACGW) 126 for managing API callbacks as an infrastructure component. ACGW 126 facilitates external action requests as part of the workflow execution process. For example, ACGW 126 can collaborate with third-party services to implement custom actions with callbacks and interaction (e.g., in addition to custom events). Accordingly, ACGW 126 offers a broader scope for integrating external functionalities into workflows than custom actions.

Event engine 118 is configured to process events and notify workflow engine 114 on event detection. For example, event engine 118 can act as an event manager that maintains the state and progress of workflows elements throughout the workflows elements' lifecycles. In such an embodiment, event engine 118 tracks the status, history, and/or metadata associated with each workflow instance, allowing for real-time monitoring, reporting, and analysis.

In an embodiment, event engine 118 facilitates external communications (e.g., event data) and action responses as part of the workflow execution process. For example, the event engine 118 can collaborate with third-party services to implement custom actions with callbacks and interaction (e.g., in addition to custom events).

In an embodiment, event engine 118 monitors event states and/or receives data regarding event states across software or systems. For example, event engine 118 can detect or determine a data event from a first system that can lead to one or many actions in a second system.

In an embodiment, event detection by event engine 118 is based on a comparison of properties associated with a specified event and obtained state data. For example, a similarity search can be conducted to determine obtained data is associated with a specific incident or environmental factors.

In an embodiment, a user can provide event data to event engine 118 using computing device 102. In another embodiment, event engine 118 itself can actively gather or request event data from computing device 102.

Optional suggestion engine 120 is configured to utilize AI models to synthesize workflow creation. For example, suggestion engine 120 can monitor the implementation of a workflow and log the details to improve system 100 effectiveness. Process metrics of workflow output can allow for automated improvement and optimization of workflow platform 104 according to an embodiment.

In an embodiment, data associated with a workflow element can be stored in elements library 106 such that statistics can be gathered for later monitoring and updating purposes. If a workflow element is not helpful (e.g., marked as such by a user), the customized workflow element can be modified or removed from elements library 106.

In an example, properties associated with workflow elements can be updated for future workflow. In particular, suggestion engine 120 can implement a feedback loop where the outcomes of workflows (e.g., successful, partially successful, unsuccessful) are used to refine and improve workflow effectiveness. For instance, if a trigger is frequently detected successfully in certain conditions but not in others, suggestion engine 120 can learn to associate the applicability of the trigger with specific environmental factors.

In another example, reinforcement learning can be used to implement a reinforcement learning model where suggestion engine 120 determines a recommended workflow element (e.g. the most effective trigger) based on rewards received for successful workflow creation. Over time, the model can optimize workflow element suggestions for various scenarios and properties, effectively learning from past actions.

In an embodiment, custom workflows can be distinguished/identified through annotations. Annotations can improve storage of workflows, which can be utilized for a wide variety of applications, such as system administration tasks (e.g., user management, disk cleanup, system monitoring), network management (e.g., firewall configuration, port scanning, network diagnostics), security purposes (e.g., log analysis, malware removal, encryption tasks), etc. In an embodiment, annotations can comprise metadata or comments that explain the purpose, parameters, and/or expected outcomes of a workflow. Annotations can further assist AI models in learning the semantic purpose behind different workflows (e.g., in addition to the workflow syntax).

In an embodiment, suggestion engine 120 optionally provides automated data labeling. For example, if a workflow monitors a number of logins associated with a user, the workflow can be labeled as a monitoring workflow. In another example, if a workflow locks out a user after a number of login attempts, the workflow can be labeled as a mitigation workflow. In an embodiment, the labeled workflows can be associated with element properties, such that workflow elements associated with a first label can be associated with a first set of properties and workflow elements associated with a second label can be associated with a second set of properties. Labeled data can be used by suggestion engine 120 to train AI models, improving future recommendations.

In an embodiment, suggestion engine 120 can, for a provided trigger, suggest a set of actions that are based on properties of the trigger. The suggestion mechanism can be based on platform data obtained during use of workflow platform 104.

With continued reference to FIG. 1, elements library 106 comprises one or more storage repositories, such as a database, logical disk space, file, or other suitable storage medium configured to store workflow elements. In an embodiment of a database, elements library 106 can be a general-purpose database management storage system (DBMS) or relational DBMS as implemented by, for example, ORACLE, IBM DB2, Microsoft SQL Server, PostgreSQL, MySQL, SQLite, LINUX, or UNIX solutions.

In an embodiment, elements library 106 can be integrated with workflow platform 104. For example, elements library 106 can be stored in memory 112.

In an embodiment, workflow platform 104 can access elements library 106. In embodiments, computing device 102, and/or external platform 108 are provided access to all or a subset of workflow elements in elements library 106 (e.g., only workflow elements applicable to a given platform or computing device can be provided), for example via workflow platform 104.

External platform 108 generally comprises callback handler 122 and repository 124. External platform 108 can be distributed across a network of multiple computing devices, each device having its own processor and memory for executing callback handler 122 and accessing data associated with repository 124. In another embodiment, external platform 108 can be implemented on a single device, such as a server, having its own processor and memory.

Callback handler 122 is an API callback handler, such as a third-party callback handler, according to embodiments. In an embodiment, callback handler 122 is configured to provide custom callbacks, for example, in response to a request payload associated with a custom action. For example, callback handler 122 can send a payload (e.g., response payload) to ACGW 126.

Repository 124 comprises one or more storage repositories, such as a database, logical disk space, file, or other suitable storage medium configured to store data associated with external platform 108. For example, vector store 108 can comprise a database (such as those described with respect to elements library 106). In an embodiment, repository 124 is configured to store parameters or attributes corresponding to the use of external platform 108. For example, repository 124 can include data structures associated with user profiles for external platform 108.

Workflow platform 104 can communicate with external platform 108 to request data from repository 124. Such data can be used to derive links or associations between workflow elements within elements library 106 and parameters of external platform 108, allowing for custom event handling.

Generally, in operation of system 100, computing device 102 is used to interact with workflow platform 104 via interface engine 116 to generate custom workflows. In particular, workflow engine 114 can develop dynamic workflows based on parameters associated with external platform 108 and/or computing device 102 in addition to workflow elements from elements library 106. In an embodiment, a user can enter certain events, triggers, actions, conditions, and properties to tailor an automated workflow for a particular purpose. In another embodiment, interface engine 116 can ping computing device 102 for such properties. Optionally, suggestion engine 120 can recommend improvements to the workflow, such as suggesting actions that are similar to but more robust than those created by the user (e.g., actions having more associated properties). Once a workflow is generated, event engine 118 can detect triggers and implement workflow operations.

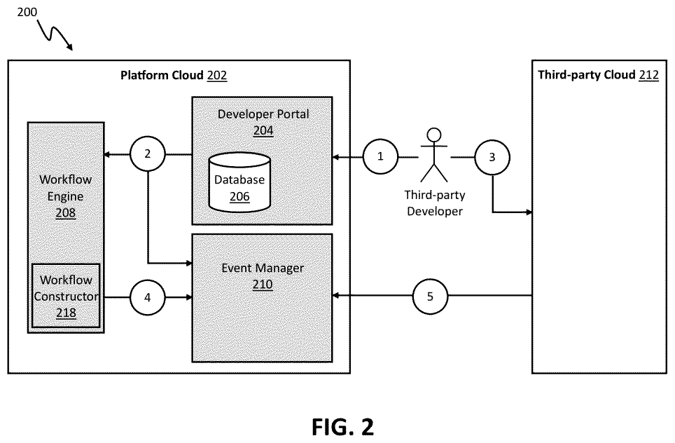

Referring to FIG. 2, a block diagram of system 200 for generating customized workflows is depicted, according to an embodiment. In an embodiment, system 200 includes many of the same components as system 100, but which are renumbered in FIG. 2 for ease of discussion.

Platform cloud 202 generally comprises developer portal 204, database 206, workflow engine 208, and event manager 210. In an embodiment, the capabilities of platform cloud 202 are the same as workflow platform 104.

Developer portal 204 comprises an interface for a user (e.g., a third-party developer) to profile custom elements and declare properties associated with the custom elements. Custom workflow elements and associated properties can be used in conjunction with native workflow elements stored in database 206. In an embodiment, database 206 can be propagated with custom workflow elements and metadata. For example, the custom elements created by the user can inherit the elements properties from database 206.

Workflow engine 208 is a service of platform cloud 202 configured to support workflow management and execution. In an embodiment, a user can interact with workflow engine 208 via developer portal 204. For example, workflow engine 208 can combine user-defined and platform elements in a single workflow. In an embodiment, workflow engine 208 includes workflow constructor 218. Workflow constructor 218 is configured to generate and pass generated workflow to workflow engine 208 to automatically activate a workflow.

Event manager 210 is a service of platform cloud 202 that processes events and notifies subscribed services based on event appearance. In an embodiment, event manager 210 can validate whether events correspond to event schema. If a custom event is detected, event manager 210 can notify relevant parties such that the workflow can progress.

In an embodiment, third-party cloud 212 can provide attribute and/or event data, for example to platform cloud 202. In examples, third-party cloud 212 can be configured with an alert mechanism that utilizes webhooks or similar technology to automatically notify platform cloud 202 of event occurrences. For example, event manager 210 can perform real-time validation of event payloads from third-party cloud 212 based on predefined schema and criteria. In an embodiment, the capabilities of third-party cloud 212 are the same as external platform 108.

With reference to FIG. 2, operation of system 200 is described with respect to an example method for creating a custom trigger based on a custom event.

At 1, a user (e.g., a third-party developer) declares a custom event in platform cloud 202 via a user interface of developer portal 204. The declaration includes: an event ID and name; an event schema (e.g., a set of event properties); and/or an association of event properties to the entities and/or attributes of platform cloud 202. For example, the declaration can include an association of a custom trigger to actions and properties that are predefined by platform cloud 202 and which can be stored in database 206.

At 2, the declared event is provided, for example by developer portal 204, to workflow engine 208 and event manager 210.

At 3, the user configures third-party cloud 212 to post an alert to platform 202. In examples, the alert can be configured to ping the platform when a particular workflow element (e.g., the custom event from 1) is satisfied. For example, if a custom workflow trigger is that a user logs into a service associated with third-party cloud 212, third-party cloud 212 can be configured to notify event manager 210 when a (e.g., each) user logs into the service. In an embodiment, third-party cloud 212 can notify/alert platform 202 via an ACGW. In such embodiments, the API can be a public API, such as a publicly available API associated with services offered by the third-party cloud.

At 4, platform cloud 202 creates a workflow via workflow constructor 218 of workflow engine 208. A user (e.g., a third party developer) can declare a custom event and/or custom action. Platform cloud 202 can enhance database 206 to include the custom event and/or custom action. The workflow can include the custom event and/or custom action declared by the user. When a workflow is activated, workflow engine 208 subscribes to receive notifications regarding the workflow from event manager 210. In examples, workflow engine 208 waits to subscribe until the workflow is active (e.g., to reduce overhead).

In an embodiment, a user, via developer portal 204, can declare custom workflow elements to be incorporated into database 206. Custom workflow elements declared by a user can be used as part of a created workflow. At 5, third-party cloud 212 detects a custom trigger based on the custom event. Third-party cloud 212 posts the event, for example by sending a payload to event manager 210 using a public API. Event manager 210 validates the event payload over the declared schema. Event manager 210 notifies workflow engine 208, for example if validation of the payload is successful.

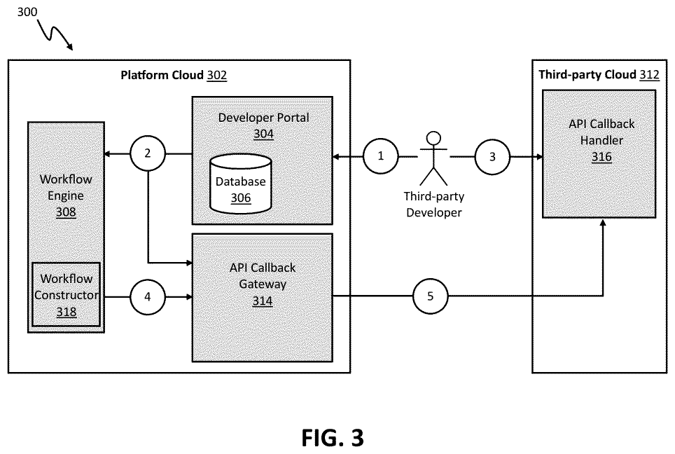

Referring to FIG. 3, a block diagram of system 300 for generating customized workflows is depicted, according to an embodiment. In an embodiment, system 300 comprises many of the same elements as system 200 with the addition of API callback gateway 214 to platform cloud 202 and API callback handler 216 to third-party cloud 212.

API callback gateway 214 serves as an intermediary for handling callbacks. API callback gateway 214 is configured to perform the role of a single exit point for all web requests to third-party handlers, such as API callback handler 216.

API callback handler 216 is a component or function responsible for processing incoming callback requests or notifications from API callback gateway 214. API callback handler 216 listens for incoming callbacks at a specified endpoint and executes predefined actions or workflows in response to these callbacks. In an embodiment, API callback handler 216 is a service that receives declared requests from platform cloud 202 and proxies the requests to an API (e.g., an API of third-party cloud 212).

With reference to FIG. 3, operation of system 300 is described with respect to an example method for creating a custom event.

At 1, a user (e.g., a third-party developer) declares entities for a custom action. The declaration includes: a custom callback; a callback schema; a custom action based on the custom callback; and an association of action properties associated with the custom action to entities and associated attributes of platform cloud 302.

At 2, developer portal 304 provides the declared entities to workflow engine 308 and API callback gateway 314.

At 3, the user configures API callback handler 316 of third-party cloud 312 to support the custom callback.

At 4, when a workflow that contains the custom action from 1 is created and activated by workflow constructor 318, workflow engine 308 composes a request payload associated with the callback and transfers the request payload to API callback gateway 314.

At 5, API callback gateway 314 interacts with API callback handler 316 and transfers its response to workflow engine 308.

The incorporation of API callback gateway 314 and API callback handler 316 as endpoints allow for asynchronous communication and event-driven architecture within distributed systems. For example, API callback gateway 314 and API callback handler 316 allow platform cloud 302 to react to external events or triggers (e.g., those occurring at third-party cloud 312) in an efficient manner.

In an embodiment, platform cloud 302 can support a callback gateway that includes integration protocols, message formats, and transport mechanisms beyond an API of a particular third-party system.

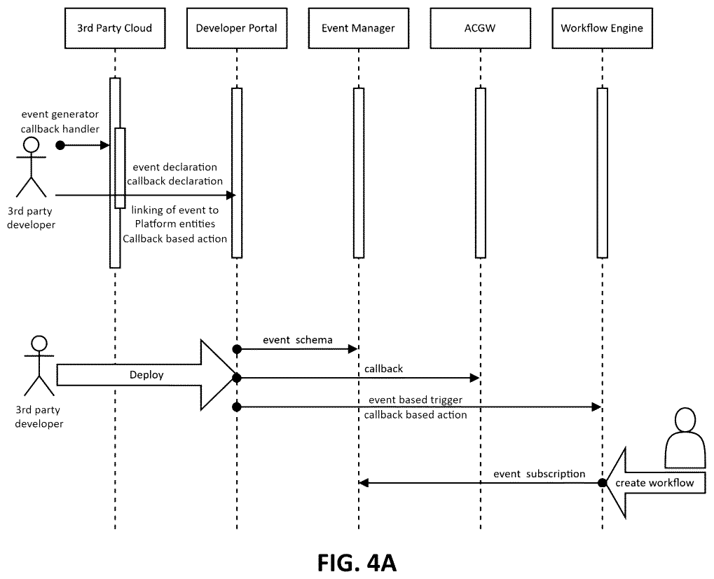

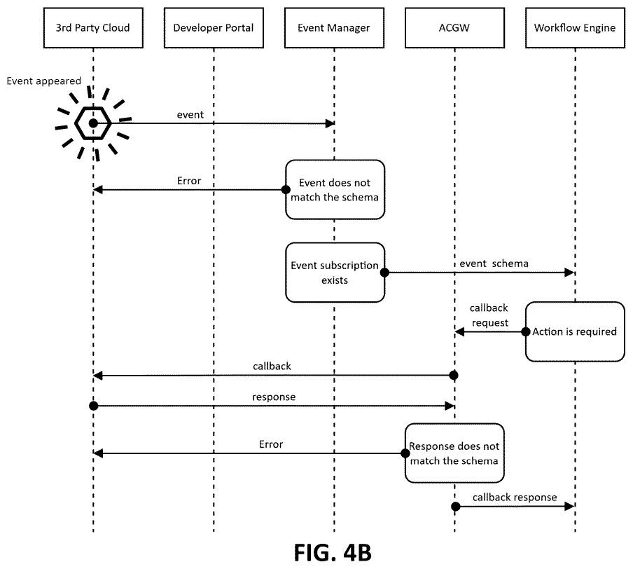

Referring to FIGS. 4A-4B, process flow diagrams of a method for generating custom workflows are depicted, according to an embodiment. In embodiments, the method depicted in FIG. 4B is a continuation of that depicted in FIG. 4A. In an embodiment, the method can be implemented by system 100, 200, and/or 300 as depicted in FIGS. 1-3. When describing the method of FIGS. 4A-4B, reference will be made to comparable elements of system 200 and 300.

With reference to FIG. 4A, a user, such as a third-party developer, can implement a callback handler (e.g., callback handler 216) at a third-party cloud (e.g., third-party cloud 212). The user can, through a developer portal (e.g., developer portal 204), declare a custom event that is associated with a custom callback and a custom event schema. The custom event schema can associate (e.g., link) the custom event and callback to one or more workflow platform properties (e.g., stored at a database). For example, the custom event can be associated with a preconfigured action of a workflow engine (e.g., workflow engine 208).

A workflow can incorporate a trigger based on the custom event and an action based on the associated callback. The user can deploy the workflow using the developer portal. Deployment comprises providing the event schema to an event manager (e.g., event manager 210), the callback to an ACGW (e.g., API callback gateway 214), and the trigger and action to the workflow engine. The workflow engine can, for example upon receiving the trigger and action, subscribe to the custom event at the event manager.

If an event is detected at the third-party cloud, the event callback handler alerts the event manager. If the event manager determines the detected event does not match the custom schema, an error message can be delivered to the third-party cloud. If the event manager determines the detected event matches the schema and the workflow engine previously subscribed to the custom event, the event schema is sent to the workflow engine.

Receipt of the event schema can serve as an alert of the custom event to the workflow engine. The workflow engine is configured to track progress of the activated workflow such that a subsequent workflow element is identified. For example, the custom event can be associated with an action, a trigger, or a condition as part of the previously activated workflow. In such an example, the activated workflow can include an action to be performed responsive to a trigger including the custom event. Receipt of an indication that the custom event occurred from the event manager can prompt the workflow engine to determine that the trigger is satisfied and an action is required. The workflow engine provides a callback request associated with the required action to the ACGW.

The ACGW is configured to provide the callback to the API callback handler. The API callback handler provides a response based on the received callback. The ACGW determines whether the response provided by the API callback handler matches the custom schema (e.g., the custom schema the API callback gateway received during deployment of the activated workflow). If the response does not match the custom schema, The ACGW provides an error indication to the third-party cloud. If the response matches the custom schema, the ACGW can send the callback response to the workflow engine. Accordingly, the ACGW and the API callback handler allow for asynchronous communication and integration between the cloud platform configured to manage a workflow and the third-party platform that can be incorporated into the workflow.

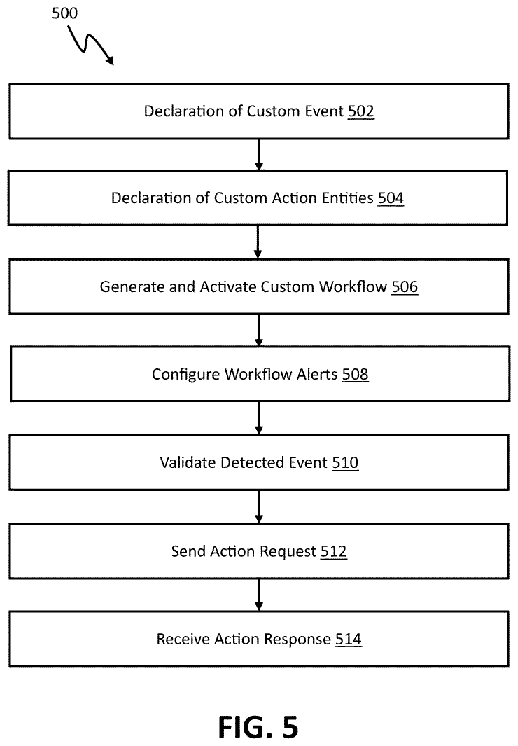

Referring to FIG. 5, a flowchart of a method 500 of generating a custom workflow is depicted, according to an embodiment. In an embodiment, method 500 can be implemented by system 100, 200, and/or 300 as depicted in FIGS. 1-3. Reference will be made to system 100 for ease of discussion.

At 502, method 500 comprises declaring a custom event. For example, at 502 a user can declare a custom event from computing device 102 using interface engine 116. In an embodiment, a custom event can be specific to discrete applications or services, such as external platform 108. In an embodiment, the declaration process includes specifying a unique event ID and name, which serves as identifiers within workflow platform 104. In such an embodiment, an event schema is detailed which outlines the properties of the custom event, and particularly how the properties are associated with (e.g., relate to) existing workflow elements within workflow platform 104 (e.g., entities and attributes stored in elements library 106). The event schema allows event engine 118 to understand and process the event data correctly.

In an embodiment, interface engine 116 provides a developer portal comprising a graphical user interface (GUI) configured for ease of use by third-party developers. In such embodiments, users can declare custom events and workflow elements specific to their applications or services through the developer portal. In an embodiment, custom workflow events can be automatically recommended by suggestion engine 120, for example based on declarative programming.

Declarative programming is a programming paradigm that expresses the logic of a computation without describing its control flow. Declarative programming focuses on what the program should accomplish, rather than how to accomplish it. This differs from imperative programming, which implements algorithms in explicit steps. Declarative programming can consider programs as theories of a formal logic, and computations as deductions in that logic space. Common declarative languages include those of database query languages (e.g., SQL, XQuery), regular expressions, and logic programming such as Prolog, Datalog, and answer set programming. Also included are functional programming, configuration management, and algebraic modeling systems. Functional programming comprises pure functional languages, such as Haskell.

At 504, method 500 comprises declaring custom action entities, such as a custom callback. A custom callback is a specific function or URL that workflow platform 104 will call to execute the action. In an embodiment, a callback schema is defined that is associated with the custom callback. The callback schema details the structure and types of data that the callback will accept and return. The callback schema allows workflow platform 202 (e.g., interface engine 116 and event engine 118) to correctly format requests to and handle responses from third-party services, such as external platform 108. In an embodiment, action properties are associated with relevant workflow elements (e.g., platform entities and attributes stored in elements library 106), establishing how the action interacts with and/or affects other elements within the workflow.

In an embodiment, a user can declare a custom callback, callback schema, and any associations with workflow elements through a developer portal provided by interface engine 116. In an embodiment, declaration of a custom callback, callback schema, and any associations with workflow elements can be automatically recommended by suggestion engine 120, for example based on previously generated workflows.

At 506, method 500 comprises generating and activating a custom workflow associated with (e.g., incorporating) the custom event (e.g., from 502) and the custom action entities (e.g., from 504). In one aspect, activation of the custom workflow can comprise deploying workflow elements associated with the custom workflow within workflow platform 104. For example, deployment of the custom workflow involves registering the custom event and/or custom action entities within workflow engine 114 and event engine 118, configuring these engines to recognize and handle the custom event.

In an embodiment, deployment of a custom workflow at 506 includes provisioning workflow elements associated with the custom workflow (e.g., the custom event and the custom action entities) to workflow engine 114. For example, the workflow engine 114 can receive the declared information from 502 and 504. Workflow engine 114 can be responsible for managing the logic and executing user-defined workflows. For example, workflow engine 114 can process workflows that incorporate the custom event as a trigger. For example, workflow engine 114 can process workflows that incorporate the custom action entities as executable elements.

In an embodiment, deployment of a custom workflow at 506 includes provisioning workflow elements associated with the custom workflow (e.g., the custom event) to event engine 118. For example, the workflow engine 114 can receive the declared information from 502. Event engine 118 can comprise an event manager configured to serve as a central hub for processing and routing event notifications, including notifications from third-party sources.

In an embodiment, deployment of a custom workflow at 506 includes provisioning workflow elements associated with the custom workflow (e.g., the custom action entities) to ACGW 126. For example, ACGW 126 can be provided by, for example, interface engine 116. ACGW 126 acts as a relay for sending action requests from workflow platform 104 to external platform 108. In an embodiment, ACGW 126 manages outbound requests related to custom actions.

In a second aspect, activation of the custom workflow at 506 can comprise composition of action request(s). In an embodiment, workflow engine 114 is configured to, upon activation of a workflow containing a custom action, compose a request payload for the custom callback. Composing the action request involves assembling data in accordance with the declared callback schema (e.g., provided by the user and/or suggestion engine). An action request can include parameters or information (e.g., properties) from the workflow context, user inputs, sources within workflow platform 104, and/or sources associated with external platform 108. The action request contains all necessary information for the custom action to be executed correctly by a receiving third-party service (e.g., external platform 108). In an embodiment, workflow engine transfers the action request to ACGW 126 upon activation of a workflow containing the custom action.

With continued reference to FIG. 5, at 508, method 500 comprises configuring workflow alerts associated with the custom workflow. In one aspect, configuring workflow alerts comprises configuring a third-party cloud service, such as external platform 108, to post events corresponding to the custom event schema to workflow platform 104. For example, external platform 108 can be configured to notify workflow platform 104 through a public API based on real-time data analysis and conditions. In such examples, the conditions can be predefined or customized, such as by a user or suggestion engine 120.

In an embodiment, third-party developers can configure cloud services to communicate with workflow platform 104 by posting alerts via an API (e.g., via ACGW). For example, configuration of cloud services can comprise preparing an external service to detect occurrences of the declared custom events. For example, configuration of cloud services can comprise arranging an API associated with external platform 108 to notify workflow platform 104 of detected occurrences. Setup can involve authenticating with workflow platform 104 and/or structuring of alert messages according to the declared event schema. In an embodiment, event alerts can be provided to event engine 118 by API callback handler 122.

In an embodiment, an event engine can automatically configure cloud services to communicate with workflow platform 104 by posting alerts via an API (e.g., via ACGW). For example, configuration of cloud services can comprise the event engine preparing an external service to detect occurrences of the declared custom events by providing the custom event schema to the external service. For example, configuration of cloud services can comprise arranging an API associated with external platform 108 to notify workflow platform 104 of detected occurrences associated with a custom event. Detection of custom events by external cloud services (e.g., third-party services) can be implemented by using real-time data monitoring to detect a predefined condition. For example, the custom event may correspond to a particular user logging in to the external platform. If the external platform detects a log-in by the user, the external platform can be configured to send a notification (e.g., API call) to workflow platform 104.

Configuring workflow alerts at 508 can comprise, in a second aspect, workflow engine 114 subscribing to notifications associated with the custom workflow. In an embodiment, workflow engine 114 subscribes to notifications from event engine 118 regarding occurrences of the custom event. For example, when a user creates a workflow that incorporates a custom event and activates the workflow, workflow engine 114 subscribes to notifications for that custom event from event engine 118 (e.g., an event manager of event engine 118). The subscription mechanism ensures that workflow engine 114 is alerted in real-time when the specified custom event occurs, allowing for the immediate initiation of the workflow. In an embodiment, subscription is based on the event ID and/or name associated with the custom event. The subscription model and/or handling by event engine 118 can ensure that only relevant events trigger the workflow at workflow engine 114.

At 510, method 500 comprises determining whether a detected event is valid. In an embodiment, event engine 118 is configured to perform validation of event data obtained by workflow platform 104. Event data can comprise payloads of workflow alerts (e.g., posted events), for example provided by callback handler 212. Validation by event engine 118 comprises comparing obtained event data to the event schema. In examples, the event schema can be a declared event schema (e.g., at 502) or an event schema provided by workflow engine 114 (e.g., during subscription at 508). In an example, the provided event schema is the declared event schema. Validation of detected events ensures that the obtained event data conforms to the expected structure and content of the custom workflow, safeguarding against processing errors and maintaining data integrity.

In an embodiment, if event engine 118 determines event data is valid, event engine 118 notifies workflow engine 114. The notification to workflow engine 114 can include an indication to initiate execution of the corresponding activated workflow based on the custom event. In an embodiment, if event engine 118 determines event data is invalid, event engine 118 can decline to notify workflow engine 114.

In an embodiment, event engine 118 can further determine whether workflow engine 114 is subscribed to notifications for the detected event. For example, if event engine 118 determines workflow engine 114 is not subscribed for the detected event, event engine 118 can decline to notify workflow engine 114. For example, if event engine 118 determines workflow engine 114 is subscribed for the detected event, event engine 118 can notify workflow engine 114. In such examples, notification to workflow engine 114 can be provided based on the determination that the event data is valid and the determination that workflow engine 114 is appropriately subscribed. The workflow engine, having previously subscribed to notifications for the custom event, can identify a corresponding workflow.

At 512, method 500 comprises sending an action request. In an embodiment, interface engine 116 can send an action request composed by workflow engine 114 at 506. The action request can comprise a request payload for the custom callback. In an embodiment, the request payload is sent from ACGW 126, for example, to a callback handler 122.

In an embodiment, ACGW 126 manages sending action requests from workflow platform 104 to a specified third-party callback handler, such as callback handler 122. After workflow engine 114 sends the composed action request to ACGW 126, ACGW 126 can forward the request to a callback handler 122. Interface engine 116 can handle aspects of the communication, including network protocols, security (e.g., authentication and encryption), and error handling. In an embodiment, interface engine 116 handles all aspects of the communication. ACGW 126 ensures that requests are delivered accurately and responses are received from the third-party service.

At 514, method 500 comprises receiving an action response. In an embodiment, interface engine 116 facilitates interaction between event engine 118 and callback handler 122 to receive an action response to the custom callback. Interface engine 116 can transfer the action response back to the workflow engine for integration into the workflow execution process.

In an embodiment, interface engine 116 transfers the action response to event engine 118. In such embodiments, event engine 118 validates the action response to identify relevant fields and values and evaluates the relationship between these values to decide if the workflow should be initiated.

Method 500 accordingly provides for the creation, provisioning, and execution of custom events and actions within a dynamic workflow automation platform. The integration of custom events and actions into the workflow platform without complex coding increases flexibility and scalability of workflow automation solutions. For example, receiving, validating, and provisioning custom events and actions, and the dynamic subscription of workflow engines to these events, provides a mechanism for dynamic integration of third-party services into workflow automation.

In an embodiment, method 500 can further comprise a codeless declaration process. Referring to FIG. 1, users can enhance an elements library such as element library 106 and/or provide custom attributes in a declarative (e.g., codeless) manner, for example, by describing what a workflow should accomplish (e.g., an outcome) rather than specifying how the platform should achieve a goal. In declarative programming, the desired outcome or behavior is defined, and the dynamic workflow platform can handle and/suggest implementation details. Implementation of declarative programming can be advantageous to simplify the user experience, for example, when a custom workflow incorporates frameworks and/or APIs from multiple third-party platforms.

In an embodiment, a workflow engine can provide a workflow recipe that comprises code defining both a trigger based on the custom event and an action based on the custom action. In examples, the workflow recipe can include criteria for event validation and action execution, for example based on the event schema and/or the action schema. For example, a workflow recipe can be a set of defined code elements that articulate how custom events serve as triggers for initiating workflows and how custom actions are executed as part of these workflows. In an embodiment, a workflow recipe includes a trigger definition, an action definition, an event validation criteria, and/or action execution conditions or criteria.

A workflow recipe includes a trigger definition, according to an embodiment. A trigger definition specifies how the custom event (e.g., declared by a user) acts as a trigger within the workflow. The trigger definition can include a mapping of event properties to workflow parameters or defining conditions under which the event activates the workflow.

A workflow recipe includes an action definition, according to an embodiment. An action definition outlines the execution logic for the custom action within the workflow context, for example, ensuring that the workflow engine understands how to call the custom action, including preparing any necessary inputs or handling outputs.

A workflow recipe includes conditions for event validation and/or action execution, according to an embodiment. For example, conditions embedded within the recipe can guide the workflow engine in validating incoming event data against the declared event schema. For example, conditions embedded within the recipe can guide the workflow engine in executing actions based on the action schema. These conditions ensure that only properly formatted events trigger workflows and that actions are executed correctly, enhancing the reliability and integrity of automated processes.

In an embodiment, configuring a third-party cloud service for integration into a custom workflow includes setting up an alert mechanism that utilizes webhooks or similar technology to automatically notify the workflow platform of event occurrences. The event manager of the workflow platform can then perform real-time validation of event payloads based on the defined schema and criteria (e.g., before proceeding with workflow activation).

In an embodiment, specific configurations for third-party cloud services can be implemented to ensure they can communicate effectively with the workflow platform. A configuration for third-party cloud services can include setting up alert mechanisms and/or real-time validation of obtained event data (e.g., event payloads). For example, the third-party service can be configured to use webhooks or similar technologies to automatically notify the workflow platform when certain events occur (e.g., events associated with triggers). Webhooks provide a straightforward way for services to send real-time HTTP POST requests to the platform, carrying data about the event occurrences. Upon receiving an event notification, the event manager of the workflow platform conducts real-time validation of the event data by comparing the incoming data against the defined schema and criteria associated with the custom event. The validation process maintains the operational integrity and relevance of the workflow (e.g., as validation prevents incorrect or malformed data from triggering automated processes).

In an embodiment, a suggestion engine generates recommendations for additional workflow actions based on the received custom event or action. For example, after a custom event or action is successfully received and processed by the platform, the suggestion engine recommends workflow elements for subsequent actions that the user might include in the workflow. Recommendations are informed by historical data on user interactions with similar events or actions within the platform. In examples, recommendations are context aware.

In an embodiment, the suggestion engine leverages a dataset including historical interactions with the platform. The dataset includes details on how users have previously responded to similar events or actions within their workflows. By analyzing patterns, frequencies, and outcomes of these past interactions, the platform can identify which actions are commonly taken in response to similar triggers (e.g., providing a personalized and context-aware automation experience for the user). In examples, historical interactions can be limited to users with similar profiles. For example, recommendations can be based only on other users that create workflows incorporating a particular third-party platform.

In an embodiment, the suggestion engine uses personalized recommendation algorithms based on machine learning techniques to predict which actions are likely to be most relevant or beneficial based on the specific context of the received custom event or action. The context can include factors such as the type of event, the attributes of the event, the sector or industry in which the user operates, and the historical workflow preferences of the user.

The outcome of the recommendation process by the suggestion engine is the provision of recommendations that are not only personalized to the historical usage patterns but are also context aware. For example, recommendations are based on the specific circumstances of the current workflow, such as the stage of the workflow in which the event occurs, the objective of the workflow, and/or any unique characteristics of the event or action itself. By doing so, the workflow platform ensures that the recommendations are relevant and timely.

In an embodiment, the workflow declaration process can prompt users to specify details for the integration and execution of custom actions within the workflow platform. For example, users are presented with recommended actions for their workflows. The recommendation process can be intuitive by providing explanations or rationales for each recommendation, aiding users in making informed decisions about their workflow configurations.

In an embodiment, custom event and action integration are described herein. The dynamic workflow platform provides a mechanism for third-party developers to declare custom events and actions through a graphical user interface (GUI). Declaration of custom events and actions allows for dynamic workflow automation tailored to third-party services or applications, enhancing flexibility and customization beyond the limited scope of predefined event topics and schemas. For example, integration of custom workflows can extend the capabilities of third-party platforms.

In an embodiment, use of a public API for event posting is described herein. For example, a configuration of third-party cloud services to post events directly to the workflow platform via a public API is provided. The use of a public API represents an open and interactive approach to event handling, allowing for a broader range of events to be integrated into workflows than, for example, event notification systems based on subscription and threshold values. In examples, the workflow platform interacts with external services via custom callbacks. The external interaction capability, especially through a defined ACGW, offers a broad integration framework.

In an embodiment, custom action entities with callbacks are described herein. Workflow automation capabilities are expanded by incorporating custom action entities, including callbacks and their associated schemas. Use of custom callbacks allows for more complex and interactive workflows that can respond to external inputs in real-time. In particular, custom actions with callbacks and interaction via the ACGW, improve integration capabilities for external functionalities compared to self-contained actions within a workflow platform.

In an embodiment, an ACGW for managing action requests is described herein. The ACGW is an infrastructure component that facilitates external communications and responses as part of the workflow execution process. The ACGW infrastructure supports a more interactive and responsive workflow automation system compared to a standalone event and workflow triggering mechanism. The ACGW is an architectural element that bolsters security and streamlines the integration process with third-party services.

In an embodiment, software recipes for dynamic handling are described herein. Activation of software recipes within the workflow engine introduces a layer of abstraction and customization, allowing the platform to dynamically adapt.

1. A system for improving data processing efficiency in dynamic workflow systems by enabling codeless enrichment of a platform's workflow elements library by third-party vendors, the system comprising:
an elements database configured to store a plurality of workflow elements;
a workflow platform communicatively coupled to the elements database and comprising a memory and at least one processor configured to implement:
an interface engine configured to:
provide a graphical user interface (GUI),
receive, via the GUI:
a custom event comprising an event identity, an event name, and an event schema, wherein the event schema includes an association between the custom event and one of the plurality of workflow elements, and
a custom action, wherein the custom action comprises a callback, a callback schema, an action, and an association between the custom action and one of the plurality of workflow elements,
receive event data associated with the event schema via a public API;
an API callback gateway (ACGW);
a workflow engine configured to:
generate a workflow incorporating the custom event,
generate an action request comprising an indication to perform the action based on the callback, wherein the action request includes data according to the callback schema; and
an event engine configured to:
receive, from the workflow engine, a subscription request associated with the custom event,
send, via the ACGW, the action request,
receive, via the ACGW, an action response associated with the action request,
determine that the action response is valid, and
send, based on the subscription request and the determination that the action response is valid, an indication that the custom event occurred to the workflow engine, wherein the workflow engine is configured to execute a portion of the workflow based on the indication that the custom event occurred.

2. The system of claim 1, wherein the workflow is generated based on a software recipe defining a trigger based on the custom event and an action based on the custom action, and wherein the software recipe includes a condition for event validation and a condition for action execution based on the custom event and the callback schema.

3. The system of claim 2, wherein the workflow comprises the trigger, and wherein the determination of whether the event data is valid is further based on the condition for event validation.

4. The system of claim 1, wherein the event engine is further configured to configure a third-party cloud service to send an action response associated with the action request to the ACGW based on the custom event or a predefined condition.

5. The system of claim 1, wherein the at least one processor is further configured to implement:
a suggestion engine configured to generate a recommended workflow element based on at least one of the custom event or the custom action, wherein an indication of the recommended workflow element is displayed via the GUI.

6. The system of claim 5, wherein the recommended workflow element is further based on historical data associated with user interactions with the workflow platform.

7. The system of claim 6, wherein the recommended workflow element is associated with a justification, and wherein the justification is displayed via the GUI.

8. The system of claim 1, wherein the workflow engine is further configured to store the custom event and the custom action as workflow elements in the elements database.

9. The system of claim 1, wherein the custom event and the custom action are received using declarative programming.

10. A method for managing a workflow using custom workflow elements, the method comprising:
receiving, via a graphical user interface (GUI):
a custom event comprising an event identity, an event name, and an event schema, wherein the event schema includes an association between the custom event and one of a plurality of predefined workflow elements, and
a custom action, wherein the custom action comprises a callback, a callback schema, an action, and an association between the custom action and one of the plurality of predefined workflow elements;
generating a workflow incorporating the custom event and/or the custom action;
generating an action request comprising an indication to perform the action based on the callback, wherein the action request includes data according to the callback schema;
receiving, via a public API, event data associated with the event schema;
determining the event data is valid based on a comparison of the event data to the event schema;
determining the custom event is associated with an active workflow subscription status; and
sending, via an API callback gateway (ACGW), the action request.

11. The method of claim 10, wherein the action response includes an indication that the action was performed and a context.

12. The method of claim 10, wherein generating the workflow is based on a software recipe that defines a trigger based on the custom event and an action based on the custom action, and wherein the software recipe includes a condition for event validation and a condition for action execution based on the custom event and the callback schema.

13. The method of claim 12, wherein the workflow comprises the trigger, and wherein the determination that the event data is valid is further based on the condition for event validation.

14. The method of claim 10, further comprising:
configuring a third-party cloud service to send an action response associated with the action request to the ACGW based on the custom event or a predefined condition.

15. The method of claim 10, further comprising:
generating a recommended workflow element based on at least one of the custom event or the custom action; and
displaying an indication of the recommended workflow element via the GUI.

16. The method of claim 15, wherein the recommended workflow element is further based on historical data associated with user interactions with the GUI.

17. The method of claim 16, wherein the recommended workflow element is associated with a justification, and wherein the method further comprises displaying the justification via the GUI.

18. The method of claim 10, further comprising storing the custom event and the custom action as predefined workflow elements.

19. A non-transitory computer readable medium comprising instructions that, when executed by a processor, cause the processor to implement:
an interface engine configured to:
provide a graphical user interface (GUI),
receive, via the GUI:
a custom event comprising an event identity, an event name, and an event schema, wherein the event schema includes an association between the custom event and one of a plurality of predefined workflow elements, and
a custom action, wherein the custom action comprises a callback, a callback schema, an action, and an association between the custom action and one of the plurality of predefined workflow elements;
receive event data associated with the event schema via a public API;
an API callback gateway (ACGW);
a workflow engine configured to:
generate a workflow incorporating the custom event, and
generate an action request comprising an indication to perform the action based on the callback, wherein the action request includes data according to the callback schema; and
an event engine configured to:
receive, from the workflow engine, a subscription request associated with the custom event,
send, via the ACGW, the action request,
receive, via the ACGW, an action response associated with the action request,
determine whether the action response is valid; and
send, based on the subscription request and a determination that the action response is valid, an indication that the custom event occurred to the workflow engine, wherein the workflow engine is configured to execute a portion of the workflow based on the indication that the custom event occurred.

20. The non-transitory computer readable medium of claim 19, wherein the instructions further cause the processor to implement:
a suggestion engine configured to generate a recommended workflow element based on at least one of the custom event or the custom action, wherein an indication of the recommended workflow element is displayed via the GUI.
